(19) United States
(12) Patent Application Publication
(10) Pub. No.: US 2024/0281319 A1
(43) Pub. Date: Aug. 22, 2024

(54) METHOD FOR OPERATING A SAFETY-CRITICAL COMPUTER SYSTEM

(71) Applicant: Robert Bosch GmbH, Stuttgart (DE)

(72) Inventors: Frank Traenkle, Erdmannhausen (DE); Panagiotis Kosioris, Urbach (DE)

(21) Appl. No.: 18/439,935

(22) Filed: Feb. 13, 2024

(30) Foreign Application Priority Data
Feb. 22, 2023 (DE) 10 2023 201 581.1

(51) Int. Cl. G06F 11/07

(52) U.S. Cl. CPC G06F 11/0793; G06F 11/0745

(57) ABSTRACT

A method for operating a safety-critical computer system which has at least two redundant channels for processing a calculation task. The channels generate results for the calculation task independently of one another. The health status of each individual channel is monitored separately. A separate decider for enabling or blocking output of the results is connected downstream of each channel. Depending on the health status of the channels, at most one of these channels is enabled for output of the results. It is ensured with the aid of a token that output of the results is blocked for all other channels.

### CROSS REFERENCE

The present application claims the benefit under 35 U.S.C. § 119 of German Patent Application No. DE 10 2023 201 581.1 filed on Feb. 22, 2023, which is expressly incorporated herein by reference in its entirety.

### FIELD

The present invention relates to a method for operating a safety-critical computer system and to such a safety-critical computer system.

### BACKGROUND INFORMATION

In many cases, computer systems, which are also referred to as compute sets, are designed as so-called safety-critical and fault-tolerant systems, in particular when used in a motor vehicle. In the case of such safety-critical systems, it should be noted that considerable damage and personal injury can occur in the event of a malfunction. In order to take this into account, it is conventional to build fault-tolerant computer systems redundantly. This means that the same functions are implemented in the computer system by units that operate largely independently of one another, which are referred to herein as channels.

For example, in two-channel redundant computer architectures for realizing fault-tolerant, safety-critical, automated or autonomous systems, homogeneously or heterogeneously redundant channels, which are also referred to as replicas, are operated in parallel. The two replicas then together form a fault-tolerant computing set or computer system which can tolerate or compensate for a failure of one of the two replicas.

This redundant computer system can be constructed not only in software but also in hardware. The two replicas can thus be implemented in operating system processes or alternatively be present in each case as individual computers or computer components with hardware and software components.

The output data or results of the computer system either represent actuators or are processed by further computer systems in a causal chain in order to deliver the overall function. Feedback can also be provided here. The possible receivers of the results are hereinafter referred to as consumers.

In a possible scenario, in the event of critical errors in channel F0, the results of channel F0 are deactivated and the results of channel F1 are activated, provided channel F1 is healthy. The results of channel F1 are switched to the outputs of the computer system. The same applies in the event of critical errors in channel F1. In this case, the results of channel F0 are switched to the outputs of the computer system, provided channel F0 is healthy.

This switchover is realized in a decider device, which is also referred to as a voter or switch. This decider device processes the results on the basis of the results of monitoring functions which are implemented, for example, as self-monitoring or cross-monitoring of the two channels.

According to the related art, decider devices can be implemented as single-channel hardware or software components. Since this decider device is logically connected in series with the computer system consisting of the two channels, a critical error of the decider device will lead to failure of the overall system. In addition, the error rate of the overall system is calculated from the sum of the error rates of the computer system and of the decider device.

This can lead to the decider device representing the critical element in the causal chain of the overall system, and safety objectives or safety requirements for the overall system possibly being violated.

### SUMMARY

Against this background, the present invention provides a method and a computer system. Example embodiments of the present invention are disclosed herein.

According to an example embodiment of the present invention, a method for operating a safety-critical computer system is provided which has at least two redundant channels, in particular heterogeneously or homogeneously redundant channels, for processing a calculation task. The calculation task can, for example, consist in performing object recognition from captured input data.

According t an example embodiment of the present invention, the channels generate results for the calculation task independently of one another. Input data can be, for example, camera or radar data, with each channel then delivering results for the calculation task, for example object recognition.

In addition, according to an example embodiment of the present invention, the health status of each individual channel is monitored separately and a separate decider for enabling or blocking output of the results is connected downstream of each channel. Depending on the health status, at most one of these channels is enabled for output of the results, wherein it is ensured with the aid of a token that output of the results is blocked for all other channels.

Consequently, it is ensured by means of a mutex algorithm that only the results of at most one channel are passed on to the consumers.

Mutex (mutual exclusion) denotes a group of methods that prevent concurrent processes from changing shared data structures in an uncoordinated manner either simultaneously or at different times. Mutex methods coordinate the temporal sequence of concurrent processes in such a way that, when processes are already in the critical section, other processes are excluded from executing critical sections.

In contrast to conventional decider devices, an improved architecture of the decider device is achieved with the method according to the present invention presented herein, so that this new decider device is fault-tolerant.

In contrast to conventional methods, according to an example embodiment of the present invention, in this new method, the decider device itself is constructed as a redundant system with two homogeneously or heterogeneously redundant channels or replicas V0 and V1. In this regard, reference is made to FIG. 1. A software and/or hardware-based implementation is possible.

The switchover between the two computer system channels is typically realized by a distributed mutex, i.e., a distributed mutual exclusion, as part of the redundant decider device. The advantages of this architecture consist in tolerating a critical error in one of the two decider channels and achieving a low error rate of the decider device.

Furthermore, the example method of the present invention solves, at least in design, the master-slave consensus problem in distributed computer systems. On the one hand, the master-slave consensus requires that the computer system outputs only the results of the active computer system channel and deactivates the results of the inactive, faulty channel. On the other hand, it is required that all receivers, such as actuators or other computer systems in the overall causal chain, receive consistent results. Since the distributed mutex activates the results of precisely one computer system channel at any one time and deactivates the results of the other channel, all receivers receive the same, consistent results of the computer system. The aforementioned requirements are thus met by the method presented.

In one example embodiment of the present invention, it is provided that the token is always assigned to only one of the at least two deciders and, if the health status of the associated channel is impaired, is assigned to one of the other deciders, wherein the assignment is initiated by the decider that is in possession of the token.

In addition, according to an example embodiment of the present invention, it can be provided that the token is provided with information about the health status of the decider which is in possession of the token, and with information about the health status of the associated channel.

In addition, the token can periodically be assigned to one of the other deciders.

In one example embodiment of the present invention, the computer system has a first channel and a second channel, wherein a first decider is connected downstream of the first channel and a second decider is connected downstream of the second channel. In this embodiment, the computer system thus has two, in particular heterogeneously or homogeneously, redundant channels.

In a further example embodiment of the present invention, a monitoring function is connected downstream of each of the deciders, which monitoring function monitors the health status of the corresponding decider and blocks output of the results of the corresponding channel if the health status of the associated decider is impaired. This embodiment is used in particular in a computer system that has two channels.

In this example embodiment of the present invention, each monitoring function can generate a new token and transmit the token to the decider not associated with it if the health status of the associated decider is impaired. The new token replaces a lost token or a token already assigned by the deciders.

In the event that all channels are recognized as faulty, it is provided in the example embodiment that no results are output.

According to an example embodiment of the present invention, a computer system is also provided that is set up to operate the method of the present invention disclosed herein. This computer system comprises two redundant channels, in particular homogeneously or heterogeneously redundant channels, for processing a calculation task, wherein the channels generate results for the calculation task independently of one another and the health status of each individual channel is monitored separately. In addition, for each channel, the computer system comprises a separate downstream decider for enabling or blocking output of the results. In this case, it is provided that, depending on the health status of the channels, at most one of these channels is enabled for output of the results, wherein it is ensured with the aid of a token that output of the results is blocked for all other channels.

In one example embodiment of the present invention, a monitoring function is provided for each decider, which monitoring function monitors the health status of the decider, is connected downstream of the decider and, depending on the health status of the decider, enables or blocks output of the results.

Further advantages and example embodiments of the present invention can be found in the description and the figures.

Of course, the features mentioned above and those still to be explained below can be used not only in the respectively specified combinations, but also in other combinations or alone, without departing from the scope of the present invention.

### BRIEF DESCRIPTION OF THE DRAWINGS

FIG. 1 shows a schematic representation of a first example embodiment of the described arrangement according to the present invention.

FIG. 2 shows a schematic representation of a second example embodiment of the described arrangement according to the present invention.

FIG. 3 shows a possible sequence of the presented method for the basic variant in a distributed finite state machine, according to an example embodiment of the present invention.

### DETAILED DESCRIPTION OF EXAMPLE EMBODIMENTS

The present invention is represented schematically in the figures on the basis of embodiments and is described below in detail with reference to the figures.

One embodiment of the presented arrangement is referred to herein as a basic variant of an architecture which tolerates a critical error of the computer system. Further embodiments can also tolerate a critical error of the decider device itself.

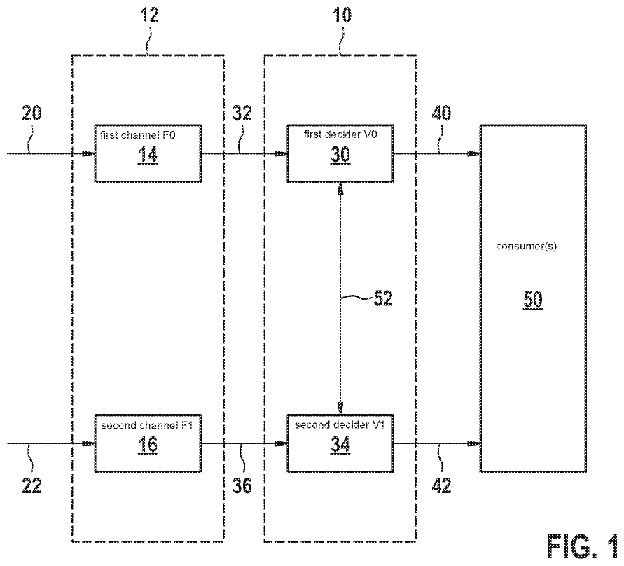

FIG. 1 shows an embodiment of the presented arrangement, which is referred to as the basic variant and is provided overall with the reference number 10. The illustration shows a computer system 12 having a first channel F0 14 and a second channel F1 16. First input data 20 flow into the first channel F0 14, and correspondingly second input data 22 flow into the second channel F1 16.

The input data can be different, identical or partially identical.

The arrangement 10 has a first decider V0 30 which is associated with the first channel F0 14 and receives first health data 32 from this first channel. In addition, a second decider V1 34 is provided in the arrangement 10, which second decider is associated with the second channel F1 16 and receives second health data 36 from this second channel. The two deciders V0 30 and V1 34 together form a decider device. First results 40 can be output to consumers 50 by the first decider V0 30, and second results 42 can be output to the consumers 50 by the second decider V1 34. Which of the two results 40 or 42 will be output depends on where a key or token is located. This token is exchanged between the deciders 30 and 34 via the communication channel indicated by the double-headed arrow 52. The results 40 or 42 are in each case the results 40 or 42 of the associated channel F0 14 or F1 16 for a calculation task to be processed and are represented by data.

In the basic variant shown, the switchover between the two computer system channels 14, 16 takes place via a mutex algorithm, which is implemented distributed over the two deciders 30, 34. In this case, the decider V0 30 receives the results 40 of the first channel F0 14 and the decider V1 34 receives the results 42 of the second channel F1 16. The distributed mutex algorithm is based on a circulating token which is present exactly once in the decider device. The corresponding decider 30 or 34 forwards the results 40 or 42 of its channel 14 or 16 precisely when said decider is in possession of this token. The other decider 30 or 34, which is not in possession of the token, simultaneously blocks the results 40 or 42 of its associated channel 14 or 16.

Each of the two deciders 30, 34 has input signals for the fault status and/or health status of the channel 14 or 16. These signals are calculated by monitoring functions that detect faults in the channels 14, 16 and/or determine the health status of the channels 14, 16.

In the initial state, either the decider V0 30 or the decider V1 34 can be in possession of the token. In the following, it is assumed that initially decider V0 30 is in possession of the token and thus forwards the results 40 of channel F0 14 to the consumers 50.

If a fault or loss of health of the channel F0 14 is communicated to the decider V0 30, the decider V0 30 then sends the token to the other decider V1 34. As a result, the decider V0 30 loses the token. It blocks communication of the results 40 of the channel F0 14. The decider V1 34 receives the token and activates forwarding of the results 42 of the channel F1 16 to the consumers 50 under the condition that the channel F1 16 is healthy.

If, on the other hand, the monitoring functions signal that the channel F1 16 is faulty or not healthy, the decider V1 34 then blocks the results 42 of the channel V1 16. As a result, a double error of the computer system 10, i.e. both channels 14, 16 having critical errors simultaneously, is recognized and transferred into a fail-silent state, i.e. no results 40, 42 are passed on to the consumers 50.

The two preceding sections apply correspondingly in the event of loss of health of the channel F1 16, in which case the token is transferred from the decider V1 34 to the decider V0 30.

In this way, if a critical fault is present in one of the two channels 14, 16, the results 40 or 42 of the defective channel 14 or 16 will be deactivated and the results 40 or 42 of the healthy channel 14 or 16 be activated. There is a switchover from the defective channel 14 or 16 to the healthy channel 14 or 16. Furthermore, master-slave consensus is achieved. All consumers 50 receive consistent results 40 or 42 of exactly one channel, either 14 or 16.

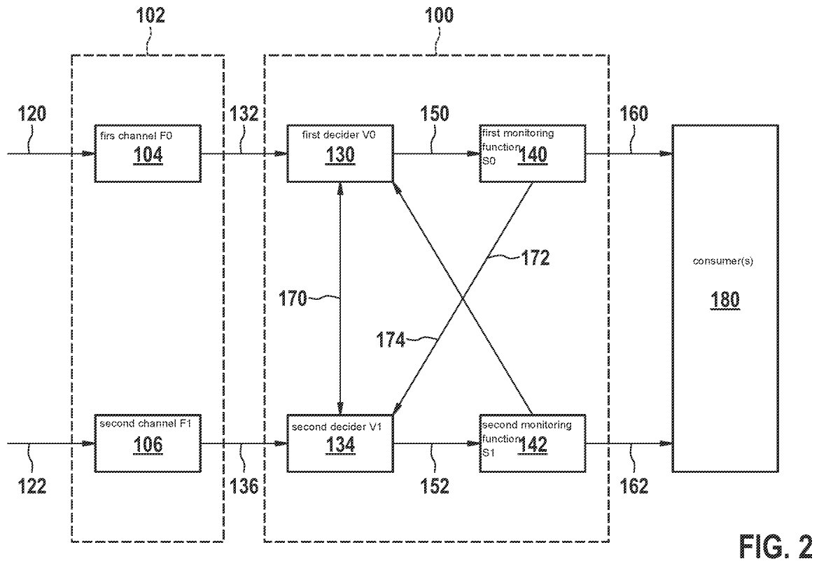

FIG. 2 shows a further embodiment of the presented arrangement which represents an extension of the basic variant shown in FIG. 1 and is denoted overall by reference number 100. The illustration shows a computer system 102 having a first channel F0 104 and a second channel F1 106. First input data 120 flow into the first channel F0 104 and correspondingly second input data 122 flow into the second channel 106.

The arrangement 100 has a first decider V0 130, which is associated with the first channel F0 104 and receives first health data 132 from this first channel. In addition, in the arrangement 100, a second decider V1 134 is provided which is associated with the second channel F1 106 and receives second health data 136 from this second channel. In addition, a first monitoring function S0 140 and a second monitoring function S1 142 are provided, which are in each case associated with a decider V0 130 and V1 134 and which in each case receive health data 150 and 152 from the assigned decider V0 130 and V1 134. The two deciders V0 130 and V1 134 and the two monitoring functions S0 140 and S1 142 form a decider device.

First results 160 can be output to consumers 180 by the first decider V0 130, and second results 162 can be output to the consumers 180 by the second decider V1 134. Which of the two results 160 or 162 will be output depends on where keys or tokens, indicated by double-headed arrows 170, 172 and 174, are located. The results 160, 162 are in each case returned to the channels 104, 106.

In the embodiment shown, an expansion is thus provided for the two deciders V0 130 and V1 134 by the two monitoring functions S0 140 and S1 142. These monitoring functions S0 140 and S1 142 detect faults or ascertain the health status of the two deciders V0 130 and V1 134. If the monitoring function S0 140 detects a critical error or loss of health in the decider V0 130, the monitoring function S0 140 then deactivates the sending of the results 160 by the decider V0 130. In addition, the monitoring function S0 140 sends a new token to the other decider V1 134.

The same applies to the monitoring function S1 142, which deactivates the results 162 from the decider V1 134 and can send a new token to the decider V0 130.

It is thereby achieved that even if one of the two deciders V0 130 or V1 134 is faulty or fails, the two channels F0 104, F1 106 are switched by generation of a new token. In addition to this tolerance of a critical error in the two deciders V0 130, V1 134, a critical error in the token communication can also be tolerated by monitoring the token communication. For example, a token loss is detected and a new token is generated by the monitoring function S0 140 or by the monitoring function S1 142.

Both embodiments described above can be expanded by a periodic transfer of the token. Unlike as described above, the sending of the token is no longer activated in the event of loss of health states, i.e. if an error is detected in a channel and/or in a decider, but instead periodically at defined time intervals.

In this expanded variant, the token contains, as a property, the status of the distributed decider. This status describes whether either the data of the channel F0 104 or of the channel F1 106 are forwarded. This status is set by the corresponding decider V0 130 or V1 134 or by the monitoring functions S0 140 and S1 142 depending on the health status of the channels F0 104, F1 106 or of the deciders V0 130, V1 134. Depending on this status, the deciders V0 130, V1 134 or the monitoring functions S0 140, S1 142 activate the forwarding of the results 160 or 162 of the associated channel 104 or 106.

This expansion makes it possible for the decider V0 130 to detect and respond to a failure of the decider V1 134 or of the monitoring function S1 142 if the transfer of the token does not take place within a defined time interval. The same statement applies to the decider V1 134, which can detect and react to a failure of the decider V0 130 or of the monitoring function S0 140.

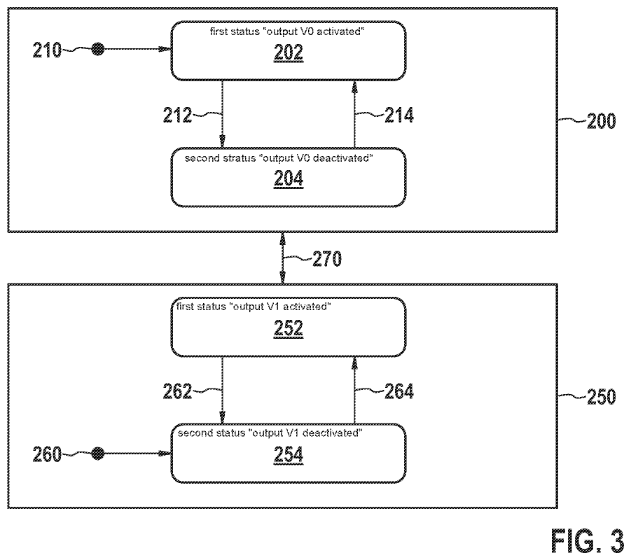

FIG. 3 shows a possible sequence of the presented method for the basic variant in a distributed finite state machine. The illustration shows a first region for a decider V0 and a second region for a decider V1. A first status 202 “output V0 activated” and a second status 204 “output V0 deactivated” are shown in the first region 200. A start is indicated by reference number 210. A first arrow 212 illustrates a change of status triggered by an event “health status not OK”, combined with an action “send token to V1.” A second arrow 214 illustrates a change of status triggered by an event “token received from V1”.

A first status 252 “output V1 activated” and a second status 254 “output V1 deactivated” are shown in the second region 250. A start is indicated by reference number 260. A first arrow 262 illustrates a change of status triggered by an event “health status not OK”, combined with an action “send token to V0.” A second arrow 214 illustrates a change of status triggered by an event “token received from V0”.

What is claimed is:

1. A method for operating a safety-critical computer system which has at least two redundant channels for processing a calculation task, the method comprising the following steps:
generating results for the calculation task by the channels independently of one another;
monitoring a health status of each individual channel of the channels separately;
wherein a separate decider for enabling or blocking output of the results is connected downstream of each of the channels, and depending on the health status of the channels, enabling at most one of the channels for output of the results, wherein it is ensured using a token that output of the results is blocked for all other channels of the channels.

2. The method according to claim 1, wherein the token is always assigned to only one decider of the at least two deciders and, when the health status of the channel to which the decider is connected is impaired, the token is assigned to one of the other deciders, wherein the assignment is initiated by the decider that is in possession of the token.

3. The method according to claim 2, wherein the token is provided with information about the health status of the decider which is in possession of the token, and with information about the health status of the channel to which the decider which is in possession of the token is connected.

4. The method according to claim 2, wherein the token is periodically assigned to one of the other deciders.

5. The method according to claim 1, wherein the computer system has a first channel and a second channel, wherein a first decider is connected downstream of the first channel and a second decider is connected downstream of the second channel.

6. The method according to claim 1, wherein a monitoring function is connected downstream of each of the deciders, each monitoring function monitors a health status of the decider to which it is connected and blocks output of the results of the the channel to which the decider is connected when the health status of the decider is impaired.

7. The method according to claim 6, wherein each monitoring function generates a new token and transfers the token to a decider not associated with it when the health status of the decider to which the monitoring function is connected, is impaired, wherein the new token replaces a lost token or a token already assigned by the deciders.

8. The method according to claim 1, wherein, in the event of all channels are detected as faulty, no results are output.

9. A computer system, comprising:
two redundant channels for processing a calculation task, wherein the channels generate results for the calculation task independently of one another, and a health status of each individual channel is monitored separately; and
a separate downstream decider for each channel, for enabling or blocking output of the results;
wherein, depending on the health status of the channels, at most one of these channels is enabled for output of the results, wherein it is ensured using a token that output of the results is blocked for all other channels.

10. The computer system according to claim 9, wherein a monitoring function is provided for each decider connected downstream of the decider, each monitoring function monitors the health status of the decider to which it is connected, and enables or blocks output of the results depending on the health status of the decider to which it is connected.
